(19) United States
(12) Patent Application Publication
(10) Pub. No.: US 2004/0162789 A1
(43) Pub. Date: Aug. 19, 2004

(54) eRoom user aging tool and method

(76) Inventors: Anthony Alan Huscher, Rocklin, CA (US); Kevin Donald Keller, Citrus Heights, CA (US); Troy Charles Whitlow, Roseville, CA (US)

Correspondence Address: HEWLETT-PACKARD DEVELOPMENT COMPANY, Intellectual Property Administration, P.O. Box 272400, Fort Collins, CO, 80527-2400, US

(21) Appl. No.: 10/368,523

(22) Filed: Feb. 14, 2003

(51) Int. Cl. G06F 17/60

(52) U.S. Cl. 705/75

(57) ABSTRACT

In one embodiment of the invention, a method of user aging in an eRoom server, includes: sending a request for eRoom user accounts in a Server Member List (SML); returning user account information in response to the request; checking an employment status of each user associated with a returned user account information; and processing a user account associated with a user based upon the employment status of the user. In another embodiment of the invention, an apparatus for user aging in an eRoom server, includes: an automated user aging module configured to send a request for eRoom user accounts in a Server Member List (SML) and receive user account information in response to the request; the automated user aging module further configured to check an employment status of each user associated with a returned user account information and process a user account associated with a user based upon the employment status of the user.

### TECHNICAL FIELD

This disclosure relates generally to server technology, and more particularly to an eRoom user aging tool and method.

### BACKGROUND

Web collaboration and e-business solutions may be provided by use of an application known as the eRoom server application (“eRoom”) from eROOM TECHNOLOGIES, INCORPORATED <www.eroom.com>. The eRoom server application is disclosed in, for example, U.S. Pat. No. 6,230,285 to Pito Salas et al. and in U.S. Pat. No. 6,233,600 to Pito Salas et al. The eRoom application can run on the MICROSOFT WINDOWS 2000 server family of products from MICROSOFT CORPORATION. One version of eRoom can be deployed using either a built-in database engine which utilizes SQLAnywhere or deployed using the Microsoft SQL 2000 server or SQL Server 7 database. The eRoom application also has a dynamic link library (DLL) called “eRoomAPI.dll” (also referred to as the “eRoom DLL”).

In the current eRoom server technology, the tracking of inactive users of the eRoom server (i.e., users who have not logged in for an extended amount of time to the eRoom server) is manually performed by a network support person. This manual process involves looking at the last login time/date for every user who has logged in at the server. The server support person would then have to contact every user who was inactive and ask each inactive user if he/she needed their eRoom account anymore. This process is expensive as far as time and cost for the server support persons.

Therefore, the current technology is limited in its capabilities and suffers from at least the above constraints.

### SUMMARY OF EMBODIMENTS OF THE INVENTION

In one embodiment of the invention, a method of user aging in an eRoom server, includes:

sending a request for eRoom user accounts in a Server Member List (SML);

returning user account information in response to the request;

checking an employment status of each user associated with a returned user account information; and

processing a user account associated with a user based upon the employment status of the user.

The type of processing for the user account is dependent on whether the associated user has active status, limited status, or terminated status or other inactive status.

In another embodiment of the invention, an apparatus for user aging in an eRoom server, includes:

an automated user aging module configured to send a request for eRoom user accounts in a Server Member List (SML) and receive user account information in response to the request;

the automated user aging module further configured to check an employment status of each user associated with a returned user account information and process a user account associated with a user based upon the employment status of the user.

These and other features of an embodiment of the present invention will be readily apparent to persons of ordinary skill in the art upon reading the entirety of this disclosure, which includes the accompanying drawings and claims.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a functional block diagram of a system 200 for providing an automated user aging method, in accordance an embodiment of the invention.

FIG. 2 is a table showing an example pseudo-code for an automated user aging method, in accordance an embodiment of the invention.

FIG. 3 is a block diagram illustrating a summary metric 250 that can be generated by the automated user aging tool 205, in accordance with an embodiment of the invention.

### DETAILED DESCRIPTION OF PREFERRED EMBODIMENTS

In the description herein, numerous specific details are provided, such as examples of components and/or methods, to provide a thorough understanding of embodiments of the invention. One skilled in the relevant art will recognize, however, that an embodiment of the invention can be practiced without one or more of the specific details, or with other apparatus, systems, methods, components, materials, parts, and/or the like. In other instances, well-known structures, materials, or operations are not shown or described in detail to avoid obscuring aspects of embodiments the invention.

An embodiment of the invention provides a method for automatically finding the inactive users of an eRoom server, contacting or notifying the inactive users, and deactivating their account and/or deleting their account after some conditions are met. There are no known current programs or methods that automate the removal of user accounts of an eRoom server.

An embodiment of the invention advantageously provides to an eRoom server support team (or support person) a process to free up the unused user licenses without the requirement of investing support team time to support this process. An embodiment of the invention also advantageously permits an easier management of the server users by reducing the number of users on the server. A reduced number of users can speed up the server operation because the time to scan the server member list is reduced.

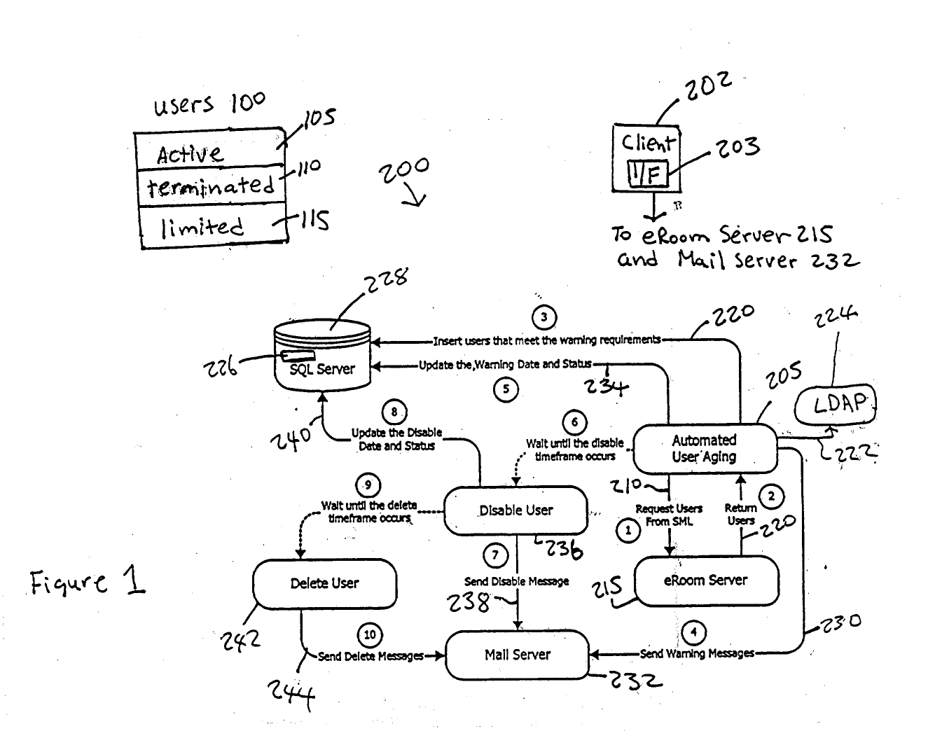

FIG. 1 is a functional block diagram of a system 200 for providing an automated user aging method, in accordance an embodiment of the invention. In one embodiment, the automated user aging method is initiated as an scheduled task (e.g., the method is initiated at a scheduled time). In step 1, an automated user aging module (i.e., automated user aging module tool) 205 sends a request 210 to an eroom server 215 for all eRoom user accounts in a Server Member List (SML). The eRoom server 215 is typically a server that runs the eRoom application. The automated user aging module 205 is typically implemented on the eRoom server 215, as a scheduled application via Windows Task Manager.

A user interface 203 in a client device 202 permits a user to provide input data and receive output information, and to interface with the eRoom application in the eRoom server 215. As known to those skilled in the art, an API is the specific method prescribed by a computer operating system or by an application program by which a programmer writing an application program can make requests to the operating system or another application.

In step 2, a first user account information 220 is returned to the automated user aging module 205, and steps 3 to 10 are then selectively performed as described below. In step 2, a second user account information 220 is then retuned to the module 205, and steps 3 to 10 is then selectively performed. Each of the remaining user account information 220 are also returned to the automated user aging module 205, and steps 3 to 10 are then selectively performed.

In the description below, the steps 3 to 10 are selectively performed whenever a user account information 220 is returned in step 2. Some of the steps 3 to 10 may be omitted, based upon the status of a user 100, as described below.

In response to a user account information 220 that is returned to the automated user aging module 205, the method proceeds to step 3. The automated user aging module 205 sends a query 222 to a directory 224 which is typically a Lightweight Directory Access Protocol (LDAP) directory. The directory 224 stores the employment status of each user 100 of the eRoom server 215. The user status is typically changed by HR (human resource) personnel through backend HR systems.

A user with an inactive status is one who falls under the category of “terminated” (i.e., the user no longer works for the company who is licensing the eRoom server application), “limited” (i.e., the user does not have employee or contractor privileges, but is not yet terminated), or other types of category indicating the user is inactive (e.g., “deceased”).

A user who falls under the active status is one who does not fall under the “terminated”, “limited” or other inactive status.

A user 100 who is active will have an active user account 105 in the eRoom server 215. A user 100 who is terminated will have a terminated user account 110 in the eRoom server 215. A user 100 who is limited will have a limited user account 115 in the eRoom server 215.

The automated user aging module 205 checks the status in the directory 224 of a user 100 associated with a user information 210 that has been returned to the automated user aging module 205. If the user 100 associated with the user information 210 falls under the “active” status, then the automated user aging module 205 checks if the user has logged into the eRoom server 215 within a given timeframe, by checking if the active user's account 105 has been used to log into the eRoom server 215. The given timeframe could be, for example, 60 days. If the active user's account has been used within the given timeframe, then the automated user aging module 205 will proceed to check another user 100 account and the active user's account 105 is left unchanged. On the other hand, if the active user's account has not been used within the given timeframe, then the automated user aging module 205 will then proceed in step 3, as described below.

In step 3, user information 220 is inserted in a database 226 in an SQL server 228, if the active user's account 105 (corresponding to that user information) has not been used within the given timeframe (e.g., 60 days). In step 3, when the user information 220 is inserted in the database 226, then

Login Name, Status, Warning Date, Disable Date, Delete Date, Cancel Date, and/or Termination date, is updated in the database when applicable.

An active user's account 105 who is inserted into the database 226 will meet warning requirements. In other words, an active status user of this active user's account 105 will be sent a warning by the automated user aging module 205 regarding this user's account 105.

In step 4, the automated user aging module 205 will send a warning message 230 to the “active” status user who had an account information inserted in the database 226 in step 3. The warning message 230 is sent via a mail server 232. The “active” status user can access the mail server 232 by, for example, use of an appropriate client device 202 or by directly accessing the mail server 232 itself. The warning message 230 may, for example, indicate to the active status user that his/her active user's account 105 has not been accessed within a given timeframe (e.g., 60 days) and that the active status user should access his/her active user's account 105 in order to keep the account 105 in active status. Other suitable warning messages 230 may be sent.

In step 5, the automated user aging module 205 will send an update 234 to the SQL server 228 to update the database 226. For example, since a warning message 230 was previously sent in step 4, the update message 234 will update the database 226 to indicate that this previous warning message 230 was sent at a particular time and/or date to alert the active status user that his/her active user account 105 should be accessed in order to prevent the account 105 from being disabled by the automated user aging module 205.

In step 6, if the active user does not log into his/her active user account 105 after the given timeframe (or the disable timeframe), which may be e.g., 60 days, then his/her active user account 105 will be disabled (as shown by block 236) by the automated user aging module 205. Alternatively, if the active user has never logged into his/her active user account 105, then the automated user aging module 205 determines if it has been 60 days (or other given timeframe length) past the creation date of the active user account 105. If so, then the active user account 105 will be disabled as shown by block 236. Subsequent steps 7 to 10 are then performed and described below for any active user account 105 that is disabled (or for any terminated user account 110 or limited user account 115 that are disabled, as discussed below). If the disable timeframe has not yet expired, then the automated user aging module 205 will wait and not yet disable the active user account 105. If the active user logs into his/her active user account 105 before expiration of the disable timeframe, then his/her active user account 105 will not be disabled in block 236.

As mentioned above, the automated user aging module 205 checks the status in the directory 224 of a user associated with a user information 210 that has been returned to the automated user aging module 205. As another example, if the user associated with the user information 210 falls under the “terminated” status after the LDAP directory 224 is checked, then the system 200 skips steps 3 to 5 above and proceeds to step 6 to process the terminated user's account 110.

In step 6, the automated user aging module 205 checks if a disable timeframe has occurred (i.e., expired). If the disable timeframe has not yet occurred (expired), then the active user's account will not yet be disabled by the automated user aging module 205. If the disable timeframe has occurred (expired), then the active user's account will be disabled by the automated user aging module 205. As an example, assume that the disable timeframe is set to sixty (60) days. The automated user aging module 205 will check if 60 days has expired, since the user's account was put on warned status (i.e., the user's account was changed into a terminated user's account 110). If 60 days has not yet expired, then in step 6 the automated user aging module 205 waits and does not yet disable the active user's account. On the other hand, if 14 days has expired, then in step 6 the automated user aging module 205 disables the active user's account as shown by block 236.

In step 7, the automated user aging module 205 will send a disable message 238 to the mail server 232 for the disabled user, indicating that his/her active user's account has been disabled.

In step 8, the automated user aging module 205 sends an update 240 to the database 226 to indicate that the active user's account has been disabled on a particular date and/or time. Thus, the automated user aging module 205 can track if the user has been notified in step 5 and step 8, by having the automated user aging module 205 access the database 226 in the SQL server 228.

In step 9, the automated user aging module 205 checks if a delete timeframe has occurred (expired) for each disabled user account that has been disabled in block 236. If the delete time frame has not occurred, then the disabled user's account will not yet be deleted by the automated user aging module 205. If the delete time frame has occurred (expired), then the disabled user's account 110 will be deleted by the automated user aging module 205 as shown by block 242.

As an example, assume that the delete timeframe is set to fourteen (14) days. The automated user aging module 205 will check if 14 days has expired since the disabled user's account 110 was disabled. If 14 days has not yet expired, then in step 6 the automated user aging module 205 waits and does not yet delete the disabled user's account 110. On the other hand, if 14 days has expired, then in step 9 the automated user aging module 205 deletes the disabled user's account 110, as represented by block 242.

In step 10, the automated user aging module 205 will send a deleted message 244 for the disabled user to the mail server 232, indicating that his/her user's account has been deleted.

If a user is on “limited” status (or other inactive status such as terminated, retired, deceased, or other inactive status), then the limited user's account 115 is processed similarly as described above for the disabled user's account. In other words, the method will skip steps 3 to step 6, in order to advantageously eliminate unnecessary processing of the user's account.

A suitable general DLL API could be used for configuring the automated user aging module 205 to provide access to the settings for the user aging method mentioned above, in one embodiment of the invention. Settings for time intervals like warning, disable and delete are set along with default messages that are stored in the database 221. Additional preconfigured database connections are established with the DLL API.

It is also noted that the messages to the user in the method above can be optionally disabled or the text of the message can be set in a manner known to those skilled in the art.

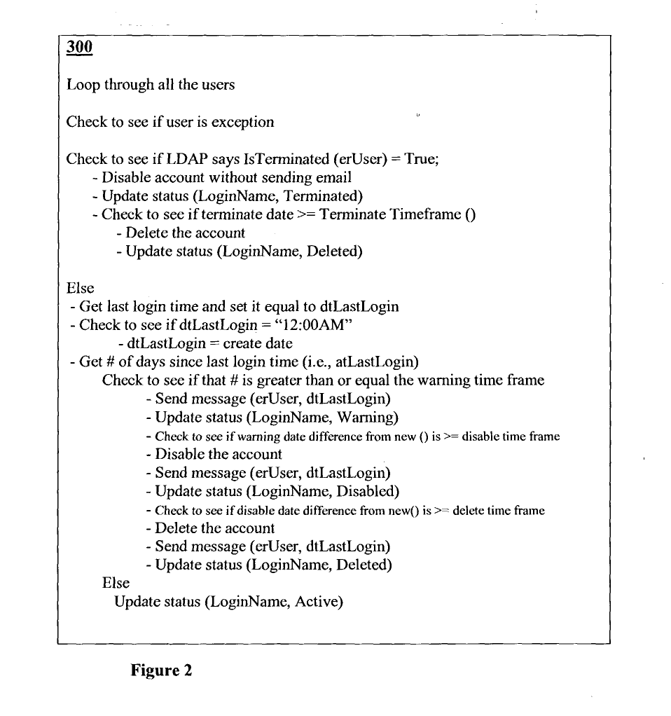

FIG. 2 is a table 300 showing an example pseudo-code for an automated user aging method, in accordance an embodiment of the invention. This table 300 corresponds to at least some of the steps mentioned in FIG. 1.

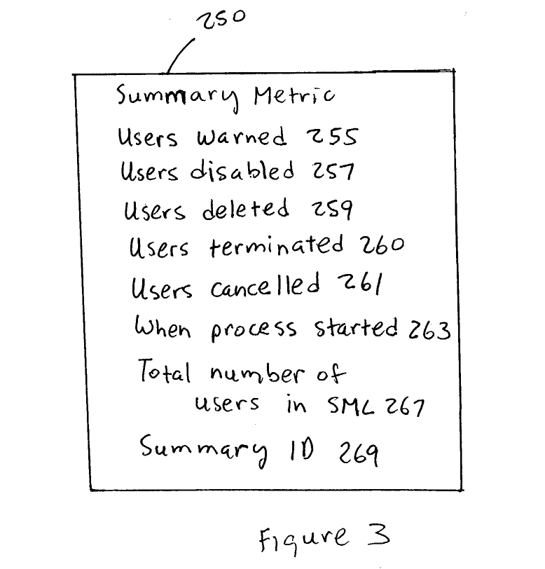

FIG. 3 is a block diagram illustrating a summary metric 250 that can be generated by the automated user aging tool 205, in accordance with an embodiment of the invention. The summary metric 250 typically comprises text fields and may be shown via a user interface 203 of a client 202 for a server administrator. The summary metric includes the following:

Users warned 255 (the users warned, as performed in step 4).

Users disabled 257 (the user accounts that are disabled).

Users Deleted 259 (the user accounts that are deleted).

Users Terminated 260 (the user accounts that are terminated).

Users cancelled 261 (Cancelled means that the user has logged in since they were warned and they will not be subjected to the disable test.).

When the process was started 263 (i.e., when the automated user aging tool 205 queried the eRoom server 215, initially).

When the process was finished 265 (i.e., when the automated user aging tool 205 has checked and processed all user accounts).

Total number of eRoom users in Server Member List (SML) 267.

Summary TD 269 (This is used as the primary key in the user aging summary metrics database, generated dynamically by the SQL Database 221).

The various engines or tools discussed herein may be, for example, software, commands, data files, programs, code, modules, instructions, or the like, and may also include suitable mechanisms.

Reference throughout this specification to “one embodiment”, “an embodiment”, or “a specific embodiment” means that a particular feature, structure, or characteristic described in connection with the embodiment is included in at least one embodiment of the present invention. Thus, the appearances of the phrases “in one embodiment”, “in an embodiment”, or “in a specific embodiment” in various places throughout this specification are not necessarily all referring to the same embodiment. Furthermore, the particular features, structures, or characteristics may be combined in any suitable manner in one or more embodiments.

Other variations and modifications of the above-described embodiments and methods are possible in light of the foregoing teaching.

Further, at least some of the components of an embodiment of the invention may be implemented by using a programmed general purpose digital computer, by using application specific integrated circuits, programmable logic devices, or field programmable gate arrays, or by using a network of interconnected components and circuits. Connections may be wired, wireless, by modem, and the like.

It will also be appreciated that one or more of the elements depicted in the drawings/figures can also be implemented in a more separated or integrated manner, or even removed or rendered as inoperable in certain cases, as is useful in accordance with a particular application.

It is also within the scope of the present invention to implement a program or code that can be stored in a machine-readable medium to permit a computer to perform any of the methods described above.

Additionally, the signal arrows in the drawings/Figures are considered as exemplary and are not limiting, unless otherwise specifically noted. Furthermore, the term “or” as used in this disclosure is generally intended to mean “and/or” unless otherwise indicated. Combinations of components or actions will also be considered as being noted, where terminology is foreseen as rendering the ability to separate or combine is unclear.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

What is claimed is:

1. A method for user aging in an eRoom server, the method comprising:
sending a request for eRoom user accounts in a Server Member List (SML);
returning user account information in response to the request;
checking an employment status of each user associated with a returned user account information; and
processing a user account associated with a user based upon the employment status of the user.

2. The method of claim 1, wherein the action of processing the user account comprises:
checking if the user has logged into the eRoom server within a given timeframe, if the user is under active status;
if the user has logged into the eRoom server within the given timeframe, then processing another user account; and
if the user has not logged into the eRoom server within the given timeframe, then updating information of the user in a database, and sending a warning to the user.

3. The method of claim 2, wherein the database is in an SQL server.

4. The method of claim 2, wherein the warning comprises an instruction for the user to access the user account to maintain active status of the user account.

5. The method of claim 2, further comprising:
updating the database to indicate that a warning was previously sent to the user.

6. The method of claim 2, further comprising:
if the user has not logged into the eRoom server within the given timeframe, then disabling the account of the user.

7. The method of claim 6, further comprising:
sending a disable message to the user, where the disable message indicates that the user account has been disabled.

8. The method of claim 6, further comprising:
deleting the user account after a delete timeframe has occurred.

9. The method of claim 8, further comprising:
sending a delete message to the user, where the delete message indicates that the user account has been deleted.

10. The method of claim 1, further comprising:
deleting the user account after a delete timeframe has occurred, if the user is on limited status.

11. The method of claim 10, further comprising:
sending a delete message to the user, where the delete message indicates that the user account has been deleted.

12. An apparatus for user aging in an eRoom server, the apparatus comprising:
means for sending a request for eRoom user accounts in a Server Member List (SML);
means for returning user account information in response to the request;
means for checking an employment status of each user associated with a returned user account information; and
means for processing a user account associated with a user based upon the employment status of the user.

13. An article of manufacture, comprising:
a machine-readable medium having stored thereon instructions to:
send a request for eRoom user accounts in a Server Member List (SML);
return user account information in response to the request;
check an employment status of each user associated with a returned user account information; and
process a user account associated with a user based upon the employment status of the user.

14. An apparatus for user aging in an eRoom server, the apparatus comprising:
an automated user aging module configured to send a request for eRoom user accounts in a Server Member List (SML) and receive user account information in response to the request;
the automated user aging module further configured to check an employment status of each user associated with a returned user account information and process a user account associated with a user based upon the employment status of the user.

15. The apparatus of claim 14, wherein the automated user aging module is configured to check if the user has logged into the eRoom server within a given timeframe, if the user is under active status;
the automated user aging module configured to process another user account if the user has logged into the eRoom server within the given timeframe and to update information of the user in a database and send a warning to the user if the user has not logged into the eRoom server within the given timeframe.

16. The apparatus of claim 15, wherein the database is in an SQL server.

17. The apparatus of claim 15, wherein the warning comprises an instruction for the user to access the user account to maintain active status of the user account.

18. The apparatus of claim 15, wherein the automated user aging module is configured to update the database to indicate that a warning was previously sent to the user.

19. The apparatus of claim 15, wherein the automated user aging module is configured to disable the account of the user if the user has not logged into the eRoom server within the given timeframe.

20. The apparatus of claim 19, wherein the automated user aging module is configured to send a disable message to the user, where the disable message indicates that the user account has been disabled.

21. The apparatus of claim 19, wherein the automated user aging module is configured to delete the user account after a delete timeframe has occurred.

22. The apparatus of claim 21, wherein the automated user aging module is configured to send a delete message to the user, where the delete message indicates that the user account has been deleted.

23. The apparatus of claim 14, wherein the automated user aging module is configured to delete the user account after a delete timeframe has occurred, if the user is on limited status.

24. The apparatus of claim 23, wherein the automated user aging module is configured to send a delete message to the user, where the delete message indicates that the user account has been deleted.
